(19) United States
(12) Patent Application Publication
(10) Pub. No.: US 2024/0375630 A1
(43) Pub. Date: Nov. 14, 2024

(54) ELECTRIC BRAKING DEVICE

(71) Applicant: ADVICS CO., LTD., Kariya-shi, Aichi-ken (JP)

(72) Inventors: Ryota MAENO, Kariya-shi, Aichi-ken (JP); Satoshi HIRATA, Kariya-shi, Aichi-ken (JP); Atsushi TAKAHASHI, Kariya-shi, Aichi-ken (JP); Tsuyoshi OTAKE, Kariya-shi, Aichi-ken (JP)

(73) Assignee: ADVICS CO., LTD., Kariya-shi, Aichi-ken (JP)

(21) Appl. No.: 18/690,199

(22) PCT Filed: Sep. 28, 2022
(86) PCT No.: PCT/JP2022/036217

§ 371 Date: Mar. 7, 2024

(30) Foreign Application Priority Data
Sep. 29, 2021 (JP) 2021-158725

(51) Int. Cl. B60T 13/74

(52) U.S. Cl. CPC B60T 13/745; B60T 13/741

(57) ABSTRACT

This electric braking device comprises a linear motion conversion mechanism having a screw shaft caused to rotate by an electric motor, and a nut that moves linearly in response to the rotation of the screw shaft. The electric braking device generates braking force in a vehicle wheel due to a piston coupled to the nut moving linearly within a cylinder and applying pressure to brake fluid. In the electric braking device, a coil spring, of which the extending/retracting direction is the linear motion direction of the piston, is installed in such a state as to be sandwiched between the piston and the screw shaft, so as to be compressed in response to the linear movement of the screw shaft in a direction for reducing braking force and to generate repulsive force against the compression.

### TECHNICAL FIELD

The disclosure here relates to an electric braking device that generates a braking force by power of an electric motor.

### BACKGROUND ART

An electric braking device that generates a braking force by a linear motion of a piston in a cylinder powered by an electric motor is known. Examples of the electric braking device include a wet type electric braking device that transmits pressing force of the piston to a friction member via a brake fluid to generate braking force, and a dry type electric braking device that directly transmits pressing force of the piston to the friction member to generate braking force.

In such electric braking device, when the electric motor loses power due to a power failure or the like during generation of the braking force, the piston is pushed back. Then, the durability of the components of the electric braking device may be impaired by the impact when the piston runs into the end of the linear motion range in the cylinder. On the other hand, Patent Literature 1 describes an electric braking device including a clutch mechanism for protecting a component from such impact. The clutch mechanism included in the electric braking device of Patent Literature 1 cuts off the power transmission path between the electric motor and the linear motion conversion mechanism when the piston in the cylinder is pushed back beyond a predetermined position.

### CITATIONS LIST

### Patent Literature

Patent Literature 1: German Patent Application Publication No. 102018214188

### SUMMARY

### Technical Problems

When the clutch mechanism as described above is provided, it is possible to protect the components of the electric braking device from the impact. However, there is a case where such clutch mechanism cannot be adopted in terms of installation space and component cost.

### Solutions to Problems

An electric braking device for solving the above problems generates a braking force on a vehicle by transmitting a rotational motion generated by an electric motor to a linear motion conversion mechanism, converting, by the linear motion conversion mechanism, the rotational motion into a linear motion for driving a piston provided in a cylinder, and pressing a friction portion that operates in response to a linear motion of the piston with respect to a reference portion against a portion subjected to friction that rotates together with a wheel of a vehicle. The electric braking device includes an elastic portion that is disposed between a linear motion portion linearly moving with respect to the reference portion in conjunction with the piston or the piston and the reference portion such that at least a part of the elastic portion is included in a movable range of the linear motion portion or the piston, and is compressed in response to linear motion of the linear motion portion in a direction of reducing the braking force to generate a repulsive force against the compression.

In the electric braking device, the friction portion is operated by linearly moving the piston with respect to the reference portion by the electric motor. Then, by the operation, the friction portion is pressed against the portion subjected to friction that rotates together with the wheel, thereby generating the braking force on the wheel. The friction portion when the friction portion is pressed against the portion subjected to friction is applied with a reaction force against the pressing, and the reaction force is also transmitted to the piston. Therefore, when the electric motor loses power due to a power failure or the like during generation of the braking force, the piston is pushed back by the reaction force. That is, the piston linearly moves in a direction of reducing the braking force. In the following description, the linear motion of the piston in the direction of reducing the braking force is referred to as rearward motion of the piston.

On the other hand, the friction portion included in the electric braking device is compressed in response to rearward motion of the piston and generates a repulsive force against the compression. The repulsive force reduces a rearward motion speed of the piston. Therefore, according to the electric braking device, an impact generated by power loss of the electric motor during generation of a braking force is mitigated.

### BRIEF DESCRIPTION OF DRAWINGS

FIG. 1 is a cross-sectional view illustrating a configuration of an electric braking device of a first embodiment.

FIG. 2 is a cross-sectional view of a cylinder and a peripheral portion thereof in an electric braking device of a second embodiment.

FIG. 3 is a cross-sectional view of a cylinder and a peripheral portion thereof in an electric braking device of a third embodiment.

FIG. 4 is a cross-sectional view of a cylinder and a peripheral portion thereof in an electric braking device of a fourth embodiment.

### DESCRIPTION OF EMBODIMENTS

### First Embodiment

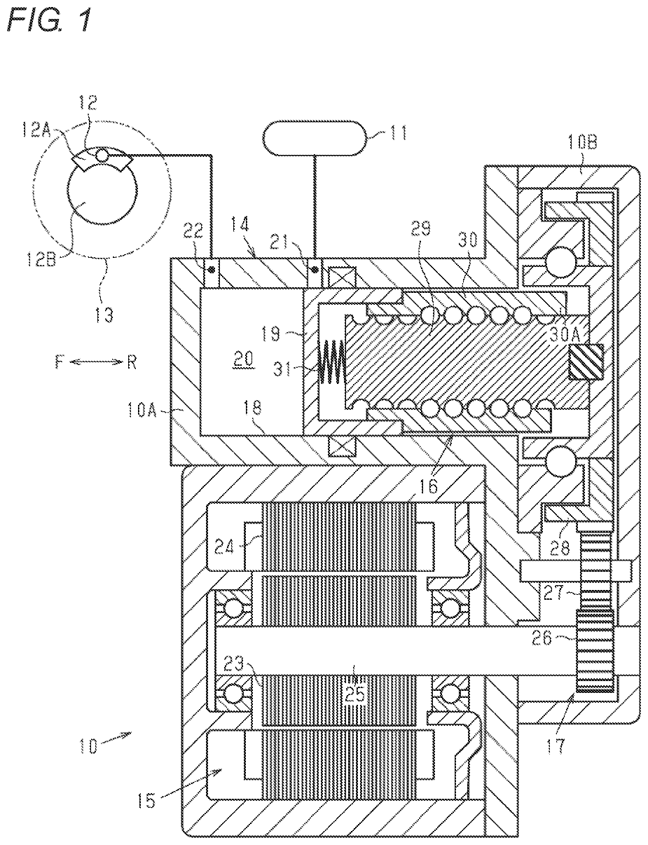

Hereinafter, a first embodiment embodying an electric braking device will be described with reference to FIG. 1. An electric braking device 10 of the present embodiment is mounted on a vehicle and generates a braking force on a wheel 13 of the vehicle.

### <Configuration of Electric Braking Device 10>

As illustrated in FIG. 1, the electric braking device 10 is connected to a reservoir tank 11 that stores a brake fluid and a wheel cylinder 12 provided on the wheel 13. Then, by generating the liquid pressure of the wheel cylinder 12, the electric braking device 10 generates a braking force on the wheel 13. More specifically, the wheel cylinder 12 operates a brake shoe 12A in response to generation of the liquid pressure. The wheel cylinder 12 generates a braking force on the wheel 13 by pressing, by the operation of the wheel cylinder 12, the brake shoe 12A against a brake disc 12B rotating together with the wheel 13. In the present embodiment, the brake shoe 12A corresponds to the friction portion. The brake disc 12B corresponds to the portion subjected to friction that rotates together with the wheel 13.

The electric braking device 10 includes a cylinder mechanism 14, an electric motor 15, a linear motion conversion mechanism 16, and a rotation transmission mechanism 17. The rotation transmission mechanism 17 decelerates and transmits, to the linear motion conversion mechanism 16, the rotation of the electric motor 15. The linear motion conversion mechanism 16 converts the rotational motion transmitted through the rotation transmission mechanism 17 into a linear motion of the piston 19 incorporated in the cylinder mechanism 14. The cylinder mechanism 14, the electric motor 15, the linear motion conversion mechanism 16, and the rotation transmission mechanism 17 are accommodated in a housing 10A. The housing 10 includes a plurality of components. The components of the housing 10A include a gear cover 10B that covers the rotation transmission mechanism 17.

The cylinder mechanism 14 includes a cylinder 18 and a piston 19 disposed in the cylinder 18 in a linearly movable manner. In the cylinder 18, a liquid chamber 20 into which the brake fluid is introduced is defined and formed by the piston 19. The volume of the liquid chamber 20 changes depending on the movement position of the piston 19 in the cylinder 18. In the following description, the movement of the piston 19 in a direction of reducing the volume of the liquid chamber 20 is referred to as forward motion of the piston 19. The movement of the piston 19 in a direction of increasing the volume of the liquid chamber 20 is referred to as rearward motion of the piston 19. Furthermore, of the direction of the linear motion of the piston 19, the forward motion side of the piston 19 is referred to as a forward motion direction F, and the rearward motion side of the piston 19 is referred to as a rearward motion direction R.

In the cylinder 18, two ports of an input port 21 and an output port 22 are formed as ports that communicate the liquid chamber 20 with the outside. The liquid chamber 20 is connected to the reservoir tank 11 through the input port 21. The liquid chamber 20 is connected to the wheel cylinder 12 through the output port 22. The output port 22 is maintained in a state of communicating with the liquid chamber 20 regardless of the movement position of the piston 19 in the cylinder 18. On the other hand, in the input port 21, when the piston 19 moves forward by a certain amount or more from the rearmost position, communication with the liquid chamber 20 is blocked by the piston 19. In the following description, a movement position of the piston 19 in which the state where the input port 21 communicates with the liquid chamber 20 and the state where that communication is blocked by the piston 19 are switched is referred to as an initial position.

The electric motor 15 includes a rotor 23 and a stator 24. A motor shaft 25 is coupled to the rotor 23 so as to rotate integrally. On the other hand, the rotation transmission mechanism 17 includes three spur gears of a first gear 26 fixed to the motor shaft 25, a second gear 27 meshed with the first gear 26, and a third gear 28 meshed with the second gear 27. As the third gear 28, a gear larger in number of teeth than the first gear 26 is used. The rotational motion of the electric motor 15 is input to the linear motion conversion mechanism 16 through the third gear 28.

The linear motion conversion mechanism 16 is a ball screw mechanism including a screw shaft 29 coupled to the third gear 28 and a nut 30 coupled to the piston 19. The linear motion conversion mechanism 16 converts the rotational motion input from the third gear 28 into a linear motion for driving the piston 19. A stopper 30A protruding in the rearward motion direction R is formed in the nut 30. An end in the rearward motion direction R in the linear motion range of the piston 19 in the cylinder 18 is a position in which the stopper 30A of the nut 30 abuts on the third gear 28. In the following description, the position of the piston 19 in which the stopper 30A of the nut 30 abuts on the third gear 28 is referred to as a rearmost position of the piston 19.

Furthermore, the electric braking device 10 includes a coil spring 31. The coil spring 31 is disposed in a part between the piston 19 and the screw shaft 29 such that the linear motion direction of the piston 19 becomes an extending/retracting direction. The coil spring 31 is disposed within a movable range of the piston 19. Therefore, the coil spring 31 is compressed in response to a rearward motion of the piston 19 in the cylinder 18. The coil spring 31 generates a repulsive force against the rearward motion of the piston 19 in response to the compression.

### Operations and Effects of Embodiment

Operations and effects of the present embodiment will be described.

In the electric braking device 10 configured as described above, the linear motion conversion mechanism 16 converts the rotational motion transmitted from the electric motor 15 into a linear motion. The piston 19 moves forward in the cylinder 18 upon receiving the linear motion and applies a pressing force to the brake fluid in the liquid chamber 20. Then, the liquid pressure of the wheel cylinder 12 is generated by this pressing force. The wheel cylinder 12 generates a braking force on the wheel 13 by pressing the brake shoe 12A against the brake disc 12B in response to generation of the liquid pressure.

The piston 19 during generation of the braking force is pushed in the rearward motion direction R by the liquid pressure in the liquid chamber 20 while being applied with the propulsive force in the forward motion direction F by the power of the electric motor 15. At this time, when the electric motor 15 loses power due to a power failure or the like, the piston 19 is pushed back and moves rearward by the liquid pressure in the liquid chamber 20. Due to this, when the piston 19 moves rearward to the rearmost position in which the stopper 30A of the nut 30 abuts on the third gear 28, an impact is generated, and the durability of the components of the electric braking device 10 may decrease.

On the other hand, in the electric braking device 10 of the present embodiment, the coil spring 31 is sandwiched between the piston 19 and the screw shaft 29. The coil spring 31 is compressed in response to the rearward motion of the piston 19, that is, the linear motion of the piston 19 in the direction of reducing the braking force, and generates a repulsive force against the compression. The repulsive force of the coil spring 31 reduces the rearward motion speed of the piston 19. As a result, a collision speed of the stopper 30A with the third gear 28 at the rearmost position decreases, and the impact due to the collision is mitigated. Therefore, according to the electric braking device 10 of the present embodiment, it is possible to mitigate the impact caused by the power loss of the electric motor 15 during generation of the braking force.

Note that in the present embodiment, the coil spring 31 corresponds to the elastic portion. In the present embodiment, the screw shaft 29 corresponds to the reference portion.

### Second Embodiment

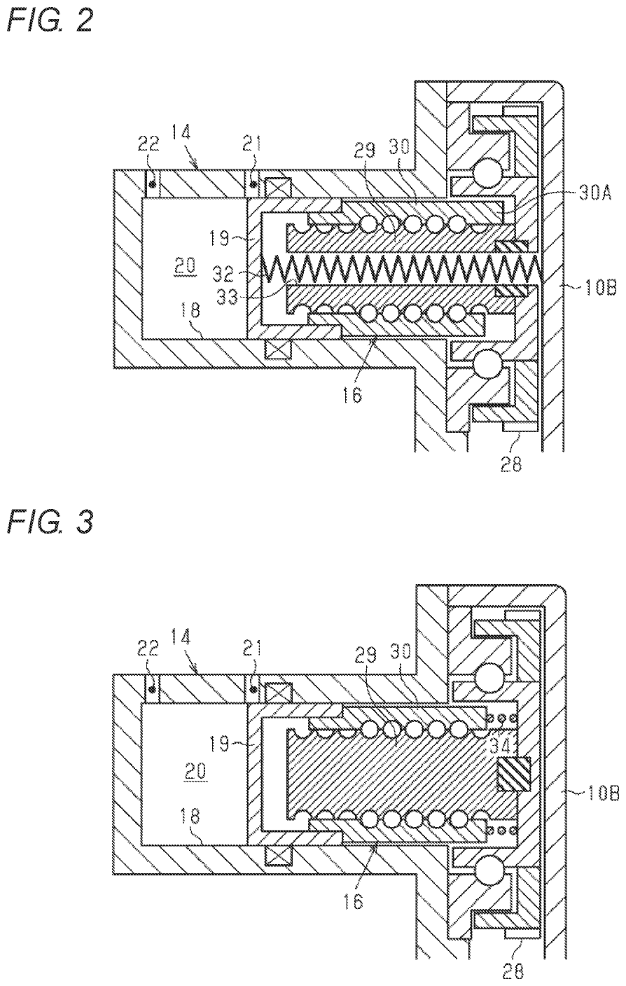

Next, the second embodiment of the electric braking device will be described also with reference to FIG. 2. FIG. 2 illustrates a cross-sectional structure of the cylinder 18 and a peripheral portion thereof in the electric braking device of the second embodiment. Note that in the present embodiment and each embodiment described later, similar configurations to those in the embodiment described above are denoted by identical reference signs, and the detailed description thereof will be omitted.

As illustrated in FIG. 2, in the screw shaft 29 and the third gear 28 of the electric braking device of the present embodiment, a through hole 33 penetrating in an axial direction of those formed. A coil spring 32 is disposed between the piston 19 and the gear cover 10B through the through hole 33. A part of the coil spring 32 is disposed within a movable range of the piston 19. By being compressed in response to the rearward motion of the piston 19, the coil spring 32 generates a repulsive force against the compression. Therefore, also the coil spring 32 can mitigate the impact caused by the power loss of the electric motor 15 during generation of the braking force.

Note that in the present embodiment, the gear cover 10B constituting the housing 10A of the electric braking device 10 becomes a reference portion that receives the coil spring 32. When movable components such as the screw shaft 29 and the third gear 28 are applied with the repulsive force of the coil spring 32, there is a possibility that the operation of the components is affected. In this regard, in the present embodiment, the reference portion that receives the coil spring 32 is the gear cover 10B, which is a non-movable component. Therefore, the influence of the repulsive force of the coil spring 32 on the operation of the electric braking device 10 is suppressed. In the present embodiment, by providing the screw shaft 29 and the third gear 28 with the through hole 33, the coil spring 32 can be disposed with the gear cover 10B positioned on the opposite side of the piston 19 across the screw shaft 29 as a reference portion.

### Third Embodiment

Next, the third embodiment of the electric braking device will be described also with reference to FIG. 3. FIG. 3 illustrates a cross-sectional structure of the cylinder 18 and a peripheral portion thereof in the electric braking device of the third embodiment.

As illustrated in FIG. 3, the electric braking device of the present embodiment is installed with a coil spring 34 of which the extending/retracting direction is the direction of the linear motion of the piston 19 in a state of being sandwiched between the nut 30 and the third gear 28. The coil spring 34 is disposed within a movable range of the nut 30. Therefore, by being compressed in response to the rearward motion of the piston 19, the coil spring 34 generates a repulsive force against the rearward motion of the piston 19. Therefore, also the coil spring 34 can mitigate the impact caused by the power loss of the electric motor 15 during generation of the braking force. Note that in the present embodiment, the third gear 28 positioned on the opposite side of the piston 19 across the nut 30 corresponds to the reference portion. The nut 30 corresponds to the linear motion portion that linearly moves with respect to the reference portion in conjunction with the piston 19.

### Fourth Embodiment

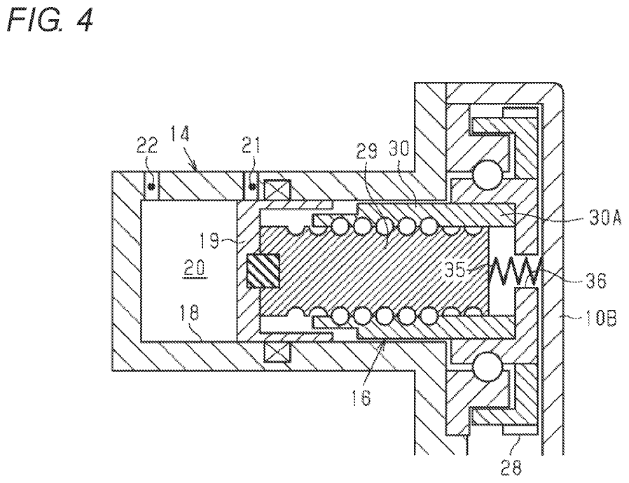

Next, the fourth embodiment of an electric braking device will be described also with reference to FIG. 4. FIG. 4 illustrates a cross-sectional structure of the cylinder 18 and a peripheral portion thereof in the electric braking device of the fourth embodiment. Note that the linear motion conversion mechanism 16 of the electric braking device of the present embodiment is configured such that the nut 30 linearly moves in response to rotation of the screw shaft 29. That is, in the present embodiment, the nut 30 is coupled to the third gear 28 so as to rotate integrally. In the present embodiment, the screw shaft 29 is coupled to the piston 19 so as to linearly move integrally.

As illustrated in FIG. 4, a through hole 36 penetrating in the linear motion direction of the piston 19 is formed in the third gear 28 of the electric braking device of the present embodiment. A coil spring 35 of which the extending/retracting direction is the direction of the linear motion of the piston 19 is installed between the screw shaft 29 and the gear cover 10B in a state of being stretched through the through hole 36. A part of the coil spring 35 is disposed within a movable range of the piston 19. Therefore, by being compressed in response to the rearward motion of the piston 19, the coil spring 35 generates a repulsive force against the rearward motion of the piston 19. Therefore, also the coil spring 35 can mitigate the impact caused by the power loss of the electric motor 15 during generation of the braking force.

Similarly to the second embodiment, also in the present embodiment, the reference portion that receives the coil spring 35 is the gear cover 10B, which is a non-movable component. Therefore, the influence of the repulsive force of the coil spring 35 on the operation of the electric braking device 10 is suppressed. In the present embodiment, by forming the through hole 36 in the third gear 28, the coil spring 35 can be disposed with the gear cover 10B positioned on the opposite side of the piston 19 across the screw shaft 29 as a reference portion.

### OTHER EMBODIMENTS

The above embodiments can be modified and carried out as follows. The above embodiments and the following modifications can be carried out in combination with each other within a range not technically contradictory.
In each of the above embodiments, the rearward motion speed of the piston 19 is reduced by the coil springs 31, 32, 34, and 35, thereby mitigating the impact caused by power loss of the electric motor 15 during generation of the braking force. The coil spring may be replaced with another elastic member that generates an elastic repulsive force in response to compression. Examples of the elastic member other than the coil spring include a leaf spring, a disc spring, a rubber spring, and an air spring.
The elastic member may be disposed at a place other than the installation places of the coil springs 31, 32, 34, and 35 in each of the above embodiments. In short, as long as an elastic member is sandwiched between a linear motion component and a non-linear motion component and is disposed so as to be compressed in response to the rearward motion of the piston 19, the rearward motion speed of the piston 19 decreases due to the repulsive force generated by the elastic member in response to the compression. Therefore, it is possible to mitigate the impact caused by the power loss of the electric motor 15 during generation of the braking force of the piston 19.
The configuration of the rotation transmission mechanism 17 that transmits the rotational motion of the electric motor 15 to the linear motion conversion mechanism 16 may be changed. Examples of the rotation transmission mechanism 17 other than the above include a bevel gear mechanism, a planetary gear mechanism, and a winding transmission mechanism. The rotation transmission mechanism 17 may be omitted, and the motor shaft 25 may be directly coupled to the linear motion conversion mechanism 16.
As the linear motion conversion mechanism 16, a mechanism other than the ball screw mechanism such as a feed screw mechanism, for example, may be adopted.
The electric braking device of the above embodiment is configured as a so-called wet type braking device that generates a braking force on the wheel 13 by transmitting the pressing force of the piston 19 to the wheel cylinder 12 via the brake fluid. The electric braking device may be configured as a dry type braking device that generates a braking force on the wheel a piston directly applying a friction member such as a brake pad with a pressing force. Even in the dry type electric braking device, when the electric motor loses power during generation of the braking force, the piston may move rearward due to the reaction force against the pressing force to generate an impact. Therefore, the impact can be mitigated by providing also the dry type electric braking device with an elastic member that is compressed in response to the rearward motion of the piston and generates a repulsive force against the rearward motion of the piston.

1. An electric braking device that generates a braking force on a vehicle by transmitting a rotational motion generated by an electric motor to a linear motion conversion mechanism, converting, by the linear motion conversion mechanism, the rotational motion into a linear motion for driving a piston provided in a cylinder, and pressing a friction portion that operates in response to a linear motion of the piston with respect to a reference portion against a portion subjected to friction that rotates together with a wheel of a vehicle, the electric braking device comprising:
an elastic portion that is disposed between a linear motion portion linearly moving with respect to the reference portion in conjunction with the piston or the piston and the reference portion such that at least a part of the elastic portion is included in a movable range of the linear motion portion or the piston, and is compressed in response to linear motion of the linear motion portion in a direction of reducing the braking force to generate a repulsive force against the compression.

2. The electric braking device according to claim 1, wherein
the linear motion conversion mechanism includes a screw shaft rotated by the electric motor and a nut linearly moving in response to rotation of the screw shaft, and
the elastic portion is disposed between the piston and the screw shaft as the reference portion.

3. The electric braking device according to claim 1, wherein
the linear motion conversion mechanism includes a screw shaft rotated by the electric motor and a nut linearly moving in response to rotation of the screw shaft,
a through hole penetrating in an axial direction is formed in the screw shaft,
the reference portion is disposed on a side opposite to the piston across the screw shaft, and
the elastic portion is provided in the through hole and is disposed between the reference portion and the piston.

4. The electric braking device according to claim 1, wherein
the linear motion conversion mechanism includes a screw shaft rotated by the electric motor and a nut linearly moving in response to rotation of the screw shaft,
the reference portion is disposed on a side opposite to the piston across the nut, and
the elastic portion is disposed between the reference portion and the nut and the piston.

5. The electric braking device according to claim 1, wherein
the linear motion conversion mechanism includes a nut rotated by the electric motor and a screw shaft linearly moving in response to rotation of the nut,
the reference portion is disposed on a side opposite to the piston across the screw shaft, and
the elastic portion is disposed between the reference portion and the screw shaft.
